(19) United States
(12) Patent Application Publication
(10) Pub. No.: US 2026/0097903 A1
(43) Pub. Date: Apr. 9, 2026

(54) PRODUCT CONVEYING DEVICE AND CUTTING MACHINE

(71) Applicant: MULTIVAC SEPP HAGGENMÜLLER SE & CO. KG, Wolfertschwenden (DE)

(72) Inventors: Matthias ROTTMAR, Wolfertschwenden (DE); Albert HARTMANN, Wolfertschwenden (DE)

(73) Assignee: MULTIVAC SEPP HAGGENMÜLLER SE & CO. KG, Wolfertschwenden (DE)

(21) Appl. No.: 19/349,485

(22) Filed: Oct. 3, 2025

(30) Foreign Application Priority Data
Oct. 4, 2024 (DE) 102024128733.0

(51) Int. Cl. B65G 23/22; B26D 7/06; B65G 15/60

(52) U.S. Cl. CPC B65G 23/22; B26D 7/0625; B65G 15/60; B26D 2210/02; B65G 2201/0202; B65G 2812/02089

(57) ABSTRACT

The disclosure relates to a product conveying device for food products, comprising a product conveyor unit which is designed to receive at least one food product on a receiving section thereof and to convey it substantially along a conveying direction from a product receiving side of the product conveying device to a product discharge side of the product conveying device, and a drive unit having a drive element rotatable about a drive axis. The drive element is operatively connected to a driven element of the product conveying unit and is arranged to drive the driven element in rotation about a driven axis thereof in order to move the receiving section of the product conveyor unit in or against the conveying direction, wherein the drive axis of the drive element is substantially parallel, preferably coaxial, to the driven axis of the driven element.

### CROSS-REFERENCE TO RELATED APPLICATIONS

This application claims foreign priority benefits under 35 U.S.C. § 119(a)-(d) to German patent application number 102024128733.0, filed October 4, 2024, which is incorporated by reference in its entirety.

### SUMMARY

The disclosure relates to a product conveying device for food products, comprising a product conveyor unit which is designed to receive at least one food product on a receiving section thereof and to convey it substantially along a conveying direction from a product receiving side of the product conveying device to a product delivery side of the product conveyor, and a drive unit comprising a drive element rotatable about a drive axis, the drive element being operatively connected to a driven element of the product conveyor unit and adapted to drive the driven element in rotation about a driven axis thereof to move the receiving section of the product conveyor unit in or against the conveying direction. The disclosure also relates to a cutting machine comprising at least one such product conveying device.

In order to assemble slices or portions cut from one or more slices of a food product, for example by means of a cutting machine, in particular a slicer, and to further process them by means of a downstream device, for example by packaging them by means of a packaging machine, it is known to obtain the food products from the cutting machine by means of a product conveying device of the type mentioned above and to transfer them in the conveying direction first to a further product conveying device or directly to the packaging machine.

The product conveying device can also be used as a portioning device, as it can also be designed to form the portions described above and/or to align portions that have already been formed and are arranged, for example, next to each other and/or behind each other in the conveying direction, along the conveying direction and/or essentially orthogonally to the conveying direction. Furthermore, the product conveyor unit may additionally or alternatively also be designed to be used in the cutting machine described above as a feed unit which is designed to feed food products, in particular in the form of product calibers, along a feed direction to a cutting unit of the cutting machine.

All of this also applies to the product conveying device according to the disclosure.

A disadvantage of known product conveying devices is that a driving force or driving torque provided by the drive unit usually has to be transmitted to the product conveying unit, for example a conveyor belt, via one or more transmissions, such as a belt drive or a gear drive or a chain drive. This means that known product conveying devices generally require a comparatively large installation space due to the large number of components arranged between the drive unit and the product conveying unit and are also highly susceptible to maintenance and/or operational faults. Furthermore, such an arrangement can lead to a delayed response, i.e., reaction of the product conveyor unit to a drive movement of the drive unit, which can make production processes in the food industry in particular more unreliable and inefficient. It is also known that the provision of a plurality of drive force transmission elements, such as the aforementioned transmissions, reduces the efficiency of the product conveying device.

It is therefore an object of the present disclosure to provide a product conveying device of the type mentioned at the outset, which can remedy this situation by eliminating at least some of the aforementioned disadvantages.

According to the disclosure, this object is achieved by a product conveying device of the type mentioned at the outset, in which the drive shaft of the drive element is essentially parallel, preferably coaxial, to the driven axis of the driven element.

Since, according to the disclosure, the drive axis of the drive element is essentially parallel, preferably coaxial, to the driven axis of the driven element, a particularly compact arrangement can be achieved, which requires less installation space than known product conveying devices of the type mentioned at the outset. The drive element of the drive unit can also be connected to the driven element as directly as possible, preferably with a minimum of intermediate drive force transmission elements or directly, which ensures a particularly responsive, low-maintenance, and efficient drive force transmission between the drive unit and the product conveyor unit. In other words, the solution according to the disclosure can essentially provide a direct drive for the product conveyor unit.

The at least one food product is preferably a food product, for example made of sausage, cheese, pressed meat or grown meat or the like. Furthermore, the at least one food product may be a food portion, which may preferably comprise one or more slices, which may be separated from a product caliber of a food product, for example by means of a cutting machine, preferably a slicer.

The product conveying device according to the disclosure may preferably be designed and intended for use with a cutting machine as a portioning device and be arranged to form food portions and/or to align portions that have already been formed and are arranged, for example, side by side and/or one behind the other in the conveying direction, along the conveying direction and/or substantially orthogonal to the conveying direction. In addition, or alternatively, the product conveyor unit may be designed and intended for use in a cutting machine as a feed unit which is arranged to feed the food products, in particular in the form of product calibers, along a feed direction to a cutting unit of the cutting machine.

In principle, the drive unit can be designed as any drive unit which can be actuated, for example, pneumatically or fluidically or in any other way. Preferably, the drive unit is designed as an electric motor, preferably as a servomotor. This allows a particularly short response time of the drive unit to be achieved, in particular when activating or deactivating the drive unit and/or when changing the direction of rotation of the drive unit.

In addition, or alternatively, the drive unit may be arranged immediately adjacent to a housing or integrated into a housing which is designed to accommodate at least one bearing unit and, optionally, one or more sealing elements of the driven element. As a result, the drive unit and at least the bearing unit and optionally the one or more sealing elements of the driven element can be arranged directly next to each other or integrated into a common housing, which enables an even more compact arrangement.

In principle, the drive unit and/or the product conveyor unit could comprise a transmission, in particular a reduction gear or the like, integrated therein, for example. However, it is preferred that the drive unit and/or the product conveyor unit, preferably the entire product conveying device, be free of a transmission, preferably a reduction gear, in particular a belt drive or a chain drive or a gear drive. This can lead to a further improved response time and/or further reduce the susceptibility of the product conveying device to malfunctions and/or wear and/or the need for maintenance of the product conveying device. It should be noted that, in this context, the inventors have overcome the technical prejudice that, when using drive units of the type described herein, a transmission, such as a reduction gear, must always be used in order to provide sufficient torque to drive the product conveyor unit. However, the inventors have recognized that, in the meantime, comparatively compact drive units, in particular in the form of electrically operated servomotors, can also provide sufficient torque or sufficient power for direct drive.

According to one embodiment, the drive element can be designed as a drive shaft, and the driven element can be designed as a driven shaft. In order to ensure easy assembly and disassembly of the product conveying device in this context, it is also proposed that one end of the drive shaft be operatively connected to an end of the driven shaft facing this end.

In order to further facilitate assembly and/or disassembly, according to a further development of this embodiment, the end of the drive shaft and the end of the driven shaft facing this end may form an axial coupling, wherein, preferably, the end of the drive shaft and the end of the driven shaft facing this end can be connected and/or separated from each other by relative movement substantially along the drive axis and/or the driven axis.

If the product conveying device comprises the axial coupling, according to another preferred further development, the end of the drive shaft can form a first axial coupling part, preferably a first claw coupling part, and the end of the driven shaft facing this end can form a second axial coupling part, preferably a second claw coupling part, which may be designed to engage with the first axial coupling part, preferably the first claw coupling part.

In order to minimize wear on the drive unit, including the drive element, and/or the product conveyor unit, including the driven element, even in the event of abrupt and/or frequent reversals in the direction of rotation of the drive unit, according to a further preferred embodiment, the product conveying device may further comprise a damping unit which is designed to act between the drive element and the driven element, wherein the damping unit may preferably be made at least partially of an elastomer. The elastomer may, for example, be formed from a rubber-like material or the like.

If the product conveying device comprises the drive shaft and the driven shaft as well as the damping unit described above, it is proposed in a further development that the damping unit operates between the end of the drive shaft and the end of the driven shaft facing this end. Furthermore, the damping unit may have a shape corresponding to the first axial coupling part and/or the second axial coupling part, wherein the damping unit may preferably be designed to be essentially star shaped. This can also ensure, for example, that the damping element can be easily replaced if this should be necessary at intervals for maintenance purposes or the like.

Furthermore, in a manner known per se, the product conveyor unit may comprise at least one conveyor belt, which may be designed to run in and/or against the conveying direction, preferably endlessly. In principle, the product conveyor unit, especially when used in conjunction with a multi-track cutting machine, it can also comprise several conveyor belts arranged next to each other essentially orthogonally to the conveying direction, which can be driven together or separately by means of the drive unit and, optionally, by means of one or more additional drive units, each of which can be designed analogously to the drive unit described above.

In order to achieve a particularly compact arrangement of the product conveying device, it is finally proposed that the at least one conveyor belt comprises at least two oppositely arranged deflection units, preferably deflection rollers or deflection cylinders, wherein each of the at least two deflection units may have a deflection axis, wherein at least one deflection axis of the at least two deflection units may coincide with the driven axis of the driven element. As a result, the driven axis of the driven element can simultaneously form a deflection axis of one of the at least two deflection units. Each deflection axis of the at least two deflection units may preferably extend substantially orthogonally to the conveying direction.

According to a further aspect, the disclosure relates to a cutting machine which comprises at least one product conveying device according to the disclosure as described above.

With regard to the advantages and effects of the cutting machine according to the disclosure, reference is made to the advantages and effects of the product conveying device according to the disclosure. All features, advantages, and effects described in relation to the product conveying device according to the disclosure also apply to the cutting machine according to the disclosure and vice versa.

The cutting machine is preferably designed to slice at least one product caliber and feed it to the product conveying device as food products. Furthermore, the cutting machine may be designed to slice food, in particular in the form of so-called product calibers, from which preferably shingled or stacked portions can be formed. The product calibers can, for example, be formed from sausage, cheese, grown meat, pressed meat, and the like. The product conveyor unit can serve as a feed unit in the cutting machine, which is designed to feed the food products, particularly in the form of product calibers, along a feed direction to a cutting unit of the cutting machine. The feed unit can, for example, be designed as an endless circulating belt conveyor or the like. The cutting unit can, for example, be designed as an electrically driven cutting unit. Preferably, the cutting unit is arranged downstream of the feed unit with respect to the feed direction. By means of a knife, which can be mounted on the cutting unit, preferably rotatable about an axis of rotation, the slices can be separated from an end of a respective product caliber facing the cutting unit.

The cutting machine can also be assigned a packaging machine, which can be arranged downstream of the product conveying device in relation to the conveying direction.

### BRIEF DESCRIPTION OF THE DRAWINGS

Embodiments according to the disclosure will be explained in more detail below with reference to the accompanying drawings.

FIG. 1 is a perspective view of several product conveying devices arranged one behind the other in a conveying direction according to the prior art;

FIG. 2 shows a partial perspective view of a product conveying device according to the disclosure in accordance with an embodiment;

FIG. 3a shows a perspective exploded view of the product conveying device according to FIG. 2;

FIG. 3b shows a perspective detailed exploded view of the product conveying device according to FIG. 2;

FIG. 4 shows a perspective exploded sectional view of the product conveying device according to FIG. 2;

FIG. 5a shows a perspective view of a cutting machine according to an embodiment; and

FIG. 5b is a side view of the cutting machine according to FIG. 5a.

### DETAILED DESCRIPTION

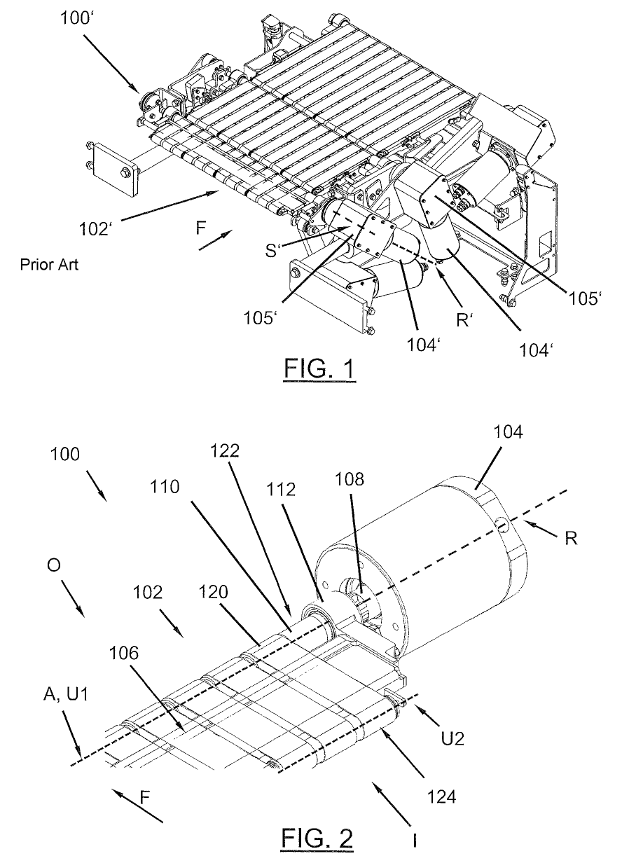

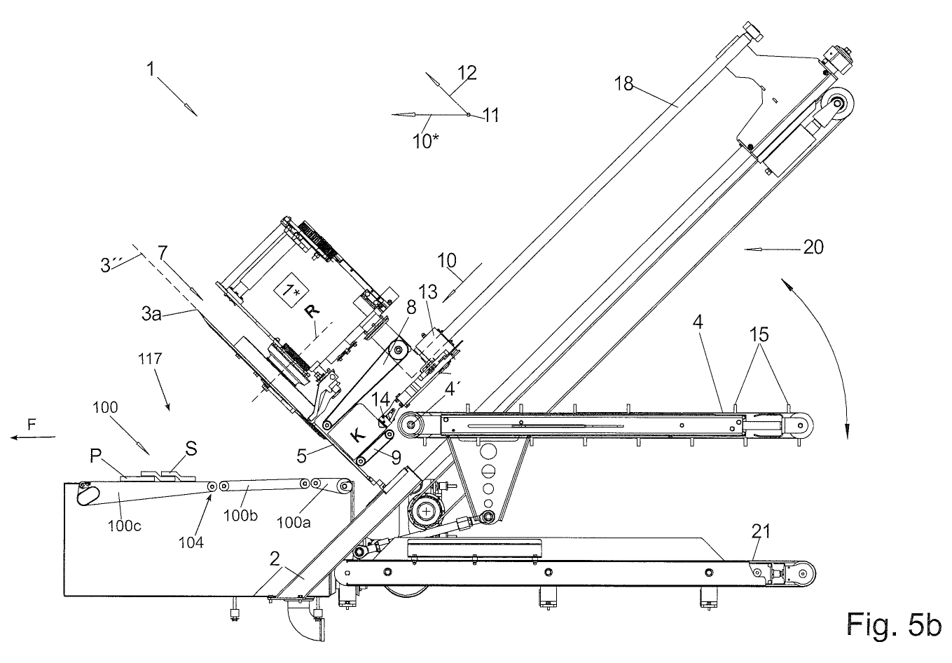

FIG. 1 shows several product conveying devices according to the prior art arranged one behind the other in a conveying direction F, of which, for example, the product conveying device furthest behind in the conveying direction F is designated by the reference numeral 100'. The product conveying device 100' comprises a product conveyor unit 102', which is designed to receive at least one food product, for example in the form of one or more slices S or one or more portions P consisting of several slices S (see FIG. 5b), and to convey it essentially along the conveying direction F.

A drive unit 104' of the product conveying device 100' is arranged in such a way that a drive shaft R' of the drive unit 104 runs essentially orthogonally to a driven axis S', which designates a rotational axis of a driven element of the product conveyor unit 102'. FIG. 1 shows that the arrangement of several such drive units 104' next to each other, which drive several product conveying devices 100' arranged one behind the other in the conveying direction F, results in some problems with regard to the available installation space, since adjacent drive units 104' must be aligned in a comparatively complex manner in order to prevent adjacent drive units 104' from colliding. In addition, each drive unit 104' shown in FIG. 1 is also assigned a transmission 105', for example in the form of a reduction gear, which further exacerbates the aforementioned problem with regard to the available installation space.

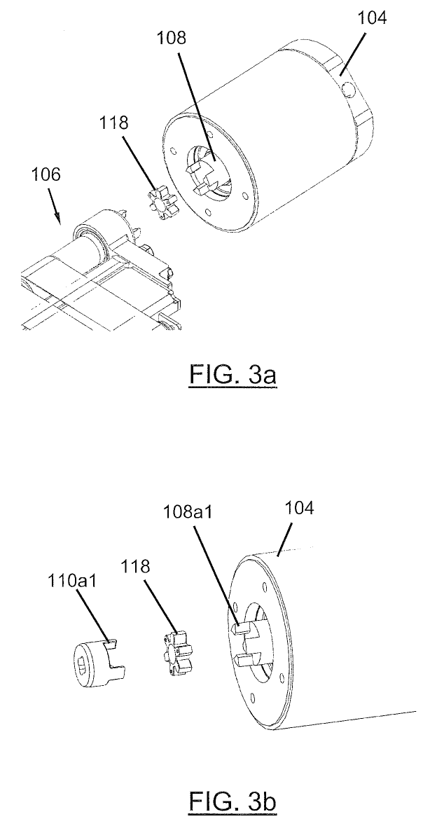

In FIG. 2, on the other hand, a product conveying device according to an embodiment of the present disclosure is generally designated by the reference numeral 100. Like the product conveying device 100' according to FIG. 1, the product conveying device 100 according to the disclosure also comprises a product conveying unit 102, which is designed to receive at least one product, which as described above may be formed as one or more slices S or one or more portions P, on a receiving section 106 thereof and to convey it substantially along the conveying direction F from a product receiving side I to a product delivery side O. The slices S may, for example, be formed from a foodstuff such as sausage, cheese, grown or pressed meat, or the like.

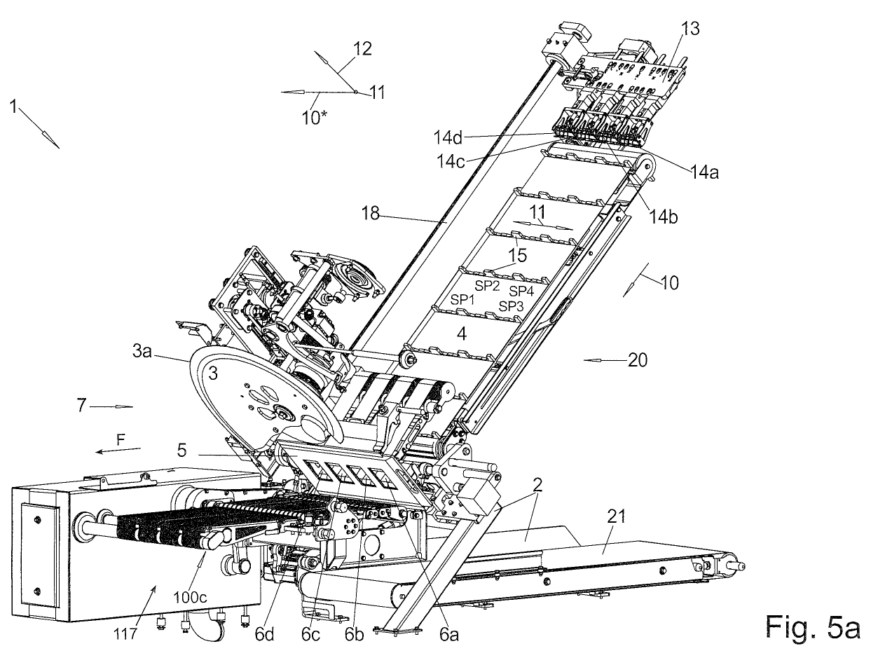

Furthermore, the product conveying device 100 comprises a drive unit 104, which has a drive element 108 that is rotatable about a drive axis of rotation R. The drive unit 104 may, for example, be designed as an electric motor, preferably as a servomotor. The drive axis R can also be seen in the sectional view according to FIG. 4. The drive element 108 can be operatively connected to a driven element 110, which is rotatable about a driven axis A, in order to move the receiving section 106 of the product conveying unit 102 in or against the conveying direction F. According to the disclosure, the drive shaft R of the drive element 104 is essentially parallel, in the embodiment shown coaxial, to the driven shaft A of the driven element 110. This significantly reduces the problem described with reference to FIG. 1 with regard to insufficient installation space, since the drive unit 104 is directly connected to the product conveyor unit 102 and, in particular, no longer needs to include an intermediate transmission 105'. If, for example, several product conveying devices 100 according to the disclosure are to be arranged one behind the other in the conveying direction F, analogous to FIG. 1, this can be done in a significantly simplified manner, since a collision of adjacent drive units 104 becomes significantly less likely. It should be noted that the product conveyor units 102 of product conveying devices 100 adjacent in the conveying direction F can, in principle, have different dimensions in the conveying direction F, as shown in FIG. 1, as can also be seen in FIG. 5b, for example.

As can be seen in particular in FIGS. 2 and 4, according to the embodiment shown, the drive unit 104 is arranged directly adjacent to a housing 112, which is designed to accommodate at least one bearing unit 114 of the driven element 110. If the driven element 110 is designed as a driven shaft, as in the present embodiment, the bearing unit 114 may, for example, be designed as a roller bearing or the like. The housing 112 may optionally also be designed to accommodate sealing elements 116a and 116b, which are intended to prevent dirt from entering the bearing unit 114. Since particularly high hygiene standards must be maintained in the food industry, the sealing elements 116a and 116b may also be designed to prevent grease or the like from escaping from the bearing unit 114 toward the receiving section 106 for the food products.

Analogous to the driven shaft 110, the drive element 108 can also be designed as a drive shaft. In the embodiment shown, one end 108a of the drive element 108 is operatively connected to an end 110a of the driven shaft 110 facing this end.

The end 108a of the drive shaft 108 and the end 110a of the driven shaft 110 form an axial coupling according to the embodiment shown. Preferably, the end 108a and the end 110a can be connected and/or separated by relative movement along the drive axis R and/or the driven axis A, which can significantly facilitate the assembly or disassembly of the drive unit 104 on the product conveyor unit 102.

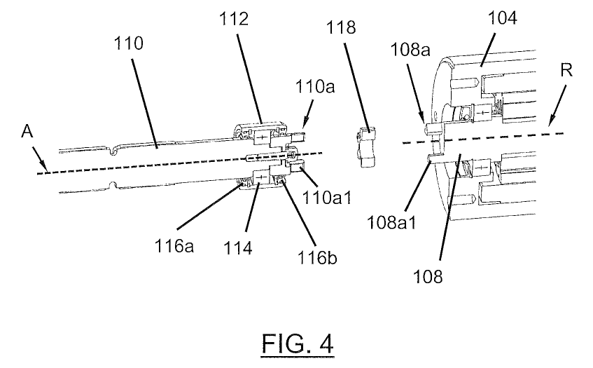

As shown in FIG. 4, the end 108a preferably forms a first axial coupling part 108a1, preferably a first claw coupling part, and the end 110a facing this end forms a second axial coupling part 110a1, preferably a second claw coupling part. The first axial coupling part 108a1 and the second axial coupling part 110a1 can engage with each other to transmit a rotational movement caused by the drive unit 104 about the axis of rotation R to the product conveyor unit 102, resulting in a rotation of the driven shaft 110 about the driven axis A. Between the end 108a and the end 110a, in particular between the first axial coupling part 108a1 and the second axial coupling part 110a1, a damping unit 118 may also be provided, which may, for example, be star-shaped (see also FIG. 3b) and/or may be made at least partially of an elastomer, for example rubber or the like.

It should be added that the product conveyor unit 102 may comprise at least one conveyor belt 120, in the embodiment shown, several conveyor belts 120 arranged essentially transversely to the conveying direction F, each conveyor belt 120 being designed to run in and/or against the conveying direction F, preferably endlessly. In the embodiment shown, endless circulation is implemented by at least two oppositely arranged deflection units in the form of a first deflection cylinder 122 and a second deflection cylinder 124. The first deflection cylinder 122 has a first deflection axis U1, while the second deflection cylinder 124 has a second deflection axis U2, as shown schematically in FIG. 2, for example. In the embodiment shown, the first deflection axis U1 coincides with the driven axis A of the driven element 110 in the form of the driven shaft.

FIG. 5a shows an embodiment of a cutting machine 1 according to the disclosure with several product conveying devices 100 according to the disclosure arranged one behind the other in the conveying direction F. For reasons of clarity, the drive units of the product conveying devices 100 are not shown in detail in FIGS. 5a and 5b, and in FIG. 5b, only one possible arrangement position of a drive unit is schematically indicated by the reference numeral 104. In the embodiment shown, the cutting machine 1 is designed in the form of a multi-track slicer 1, which is set up to simultaneously slice several product calibers K on each of the tracks SP1 to SP4 next to each other and to deposit them in shingled portions P, each consisting of several slices S. A general direction of travel 10* through the slicer 1 is indicated by the arrow with reference numeral 10*, which runs essentially parallel to the conveying direction F.

FIG. 5b shows – with product caliber K inserted – a side view of the slicer 1 with covers and other parts attached to a base frame 2 omitted so that the functional parts, especially the conveyor belts, are more easily recognizable. The longitudinal direction 10 is the feed direction of the product calibers K to a cutting unit 7 of the slicer 1 and thus also the longitudinal direction of the product calibers K lying in the slicer 1.

The cutting unit 7 of the slicer 1, with a knife 3 rotating about an axis of rotation R, for example a sickle knife 3, can be supplied by a feed unit 20 with several, in this case four, product calibers K lying side by side across the feed direction 10 on a feeder 4, with projections 15 of the feeder 4 projecting from a support surface acting as spacers between them, from whose front ends the rotating knife 3 can cut off a slice S with its cutting edge 3a during each revolution about the axis of rotation R.

For cutting the product calibers K, the conveyor 4 is in the inclined cutting position shown in FIG. 5a, with the cutting side front end low and the rear end high, from which it can be folded down by a pivot axis extending in its width direction, the first transverse direction 11, near the cutting unit 7, into an approximately horizontal loading position, as shown in FIG. 5b.

The rear end of each product caliber K located in the feed unit 20 is held in a form-fitting manner by a gripper 14 or 14a-d with the aid of gripper claws. These grippers 14 or 14a - 14d, which can be activated and deactivated with regard to the position of the gripper claws, are attached to a common gripper unit 13, which can be guided along a gripper guide 18 in the feed direction 10.

Both the feed of the gripper unit 13 and the feed conveyor 4 can be driven in a controlled manner, whereby the specific feed speed of the product calibers K can be controlled by a similarly controlled upper product guide 8 and/or lower product guide 9, which engage with the upper and lower sides of the product calibers K to be cut in their front end areas near the cutting unit 7.

The front ends of the product calibers K are each guided through a product opening 6a - d of a plate-shaped cutting frame 5, whereby the cutting plane 3" runs immediately in front of the front, obliquely downward-pointing end face of the cutting frame 5, in which the knife 3 rotates with its cutting edge 3a around the axis of rotation R and thus separates the protrusion of the product calibers K from the cutting frame 5 as a slice S. The cutting plane 3" runs orthogonally to the upper run of the feeder 4 and/or is spanned by the two transverse directions 11, 12 to the feed direction 10. The inner circumference of the product openings 6a - d serves as a counter-cutting edge for the cutting edge 3a of the knife 3.

Since both product guides 8, 9 can be driven in a controlled manner, in particular independently of each other and/or possibly separately for each track SP1 to SP4, they determine a continuous or clocked feed speed of the product calibers K through the cutting frame 5.

The upper product guide 8 can be moved in the second transverse direction 12, which runs orthogonally to the surface of the upper run of the conveyor 4, in order to adapt to a height of the product caliber K in this direction. Furthermore, at least one of the product guides 8, 9 can be designed to pivot around one of its deflection rollers in order to be able to change the direction of a guide belt of the product guide 8 and/or 9 adjacent to the respective product caliber K to a limited extent.

The slices S, which are positioned at an angle in the space when separated, fall onto a portioning unit 117 arranged below the cutting frame 5. The portioning unit 117 is formed from several product conveying devices 100 according to the disclosure in the form of a portioning and/or weighing belt 100a and further conveyors 100b and 100c arranged one behind the other in the direction of travel 10*. The direction of travel 10* can correspond to the conveying direction F of the portioning unit 117. The portioning unit 117 is accordingly designed to form the portions P from the slices S cut by the cutting unit 7 and is designed to convey the portions P along the conveying direction F.

The slices S can hit the portioning and/or weighing belt 100a individually and spaced apart from each other in the direction of travel 10*, and/or, by appropriately controlling the portioning and/or weighing belt 100a, the movement of which, like almost all moving parts, is controlled by a control unit 1* of the slicer 1, shingled or stacked portions P (see FIG. 5b) can be formed. The portions P can be formed, for example, by a stepwise forward movement of the portioning and/or weighing belt 100a in the conveying direction F.

In the embodiment shown, a substantially horizontal residue conveyor 21 is located below the feed unit 20, which begins with its front end below the cutting frame 5 and immediately below or behind the portioning unit 117 and can transport residues falling onto it to the rear with its upper run.

What is claimed is

1. A product conveying device for food products, comprising:
a product conveyor unit which is designed to pick up at least one food product on a receiving section thereof and to convey the at least one food product substantially along a conveying direction from a product receiving side of the product conveying device to a product discharge side of the product conveying device, and
a drive unit having a drive element rotatable about a drive axis, the drive element being operatively connected to a driven element of the product conveying unit and arranged to drive the driven element in rotation about a driven axis thereof in order to move the receiving section of the product conveying unit in or against the conveying direction, wherein the drive axis of the drive element is substantially parallel to the driven axis of the driven element.

2. The product conveying device according to claim 1, wherein the drive axis of the drive element is coaxial with the driven axis of the driven element.

3. The product conveying device according to claim 1, wherein the drive unit is designed as an electric motor.

4. The product conveying device according to claim 3, wherein the electric motor comprises a servomotor.

5. The product conveying device according to claim 1, wherein the drive unit is arranged immediately adjacent to a housing or is integrated into a housing which is designed to accommodate at least one bearing unit of the driven element.

6. The product conveying device according to claim 5, wherein the housing is designed to accommodate one or more sealing elements of the driven element.

7. The product conveying device according to claim 1, wherein the drive unit and/or the product conveying unit are/is free of a transmission.

8. The product conveying device according to claim 1, wherein the drive element is designed as a drive shaft and the driven element is designed as a driven shaft, wherein an end of the drive shaft is operatively connected to an end of the driven shaft facing the end of the drive shaft.

9. The product conveying device according to claim 8, wherein the end of the drive shaft and the end of the driven shaft form an axial coupling.

10. The product conveying device according to claim 9, wherein the end of the drive shaft and the end of the driven shaft can be connected to and/or separated from each other by a relative movement along the drive axis and/or the driven axis.

11. The product conveying device according to claim 9, further comprising a damping unit that operates between the end of the drive shaft and the end of the driven shaft.

12. The product conveying device according to claim 9, wherein the end of the drive shaft forms a first axial coupling part, and the end of the driven shaft forms a second axial coupling part, which is designed to engage with the first axial coupling part.

13. The product conveying device according to claim 12, wherein the first axial coupling part comprises a first claw coupling part, and the second axial coupling part comprises a second claw coupling part.

14. The product conveying device according to claim 1, wherein the product conveying device further comprises a damping unit which is designed to act between the drive element and the driven element.

15. The product conveying device according to claim 14, wherein the damping unit is made at least partially of an elastomer.

16. The product conveying device according to claim 1, wherein the product conveying unit comprises at least one conveyor belt which is designed to run in and/or against the conveying direction.

17. The product conveying device according to claim 16, wherein the at least one conveyor belt is designed to run endlessly in and/or against the conveying direction.

18. The product conveying device according to claim 16, wherein the at least one conveyor belt comprises at least two oppositely arranged deflection units, each of the at least two deflection units having a deflection axis, wherein at least one deflection axis of the at least two deflection units coincides with the driven axis of the driven element.

19. The product conveying device according to claim 18, wherein the at least two deflection units comprise deflection rollers or deflection cylinders.

20. A cutting machine comprising at least one product conveying device according to claim 1.
